(19) United States
(12) Patent Application Publication
(10) Pub. No.: US 2011/0108497 A1
(43) Pub. Date: May 12, 2011

(54) DEWATERING DEVICE HAVING A BLADDER

(75) Inventor: Ake Stigebrandt, Marstrand (SE)

(73) Assignee: STIGEBRANDT HYDROTEKNIK AB, Marstrand (SE)

(21) Appl. No.: 13/002,546

(22) PCT Filed: Jun. 16, 2009
(86) PCT No.: PCT/SE2009/050747

§ 371 Date: Jan. 4, 2011

(30) Foreign Application Priority Data
Jul. 4, 2008 (SE) 0801611-5

(51) Int. Cl. B30B 9/22; B01D 29/35; C02F 11/12

(52) U.S. Cl. 210/808; 210/416.1

(57) ABSTRACT

A dewatering device for batchwise separation of liquid from particle-laden sludge, the dewatering device comprises a closed, downwards openable container having at least one liquid-pervious wall, the container being arranged to be filled with said sludge during a filling phase, a bladder located centrally inside the container, the bladder is adapted to be filled with a fluid, and a valve system for controlling the pressure of the fluid inside the bladder, wherein compression of the bladder is prevented by having the valve system adapted to maintain an overpressure of the fluid inside the bladder, in relation to the surrounding pressure, in use of the dewatering device during said filling phase. Further present invention relates to a method for separation of liquid from particle-laden sludge using a dewatering device which comprises a container, and a bladder located centrally inside the container.

### TECHNICAL FIELD OF THE INVENTION

The present invention relates to a dewatering device for batchwise separation of liquid from particle-laden sludge, the dewatering device comprises a closed, downwards openable container having at least one liquid-pervious wall, the container being arranged to be filled with said sludge during a filling phase, a bladder located centrally inside the container, the bladder is adapted to be filled with a fluid, and a valve system for controlling the pressure of the fluid inside the bladder. Further, the present invention relates to a method for separation of liquid from particle-laden sludge using a dewatering device, which comprises a container and a bladder located centrally inside the container.

### BACKGROUND

In water purification processes residue is produced in the form of particles that must be collected. The feature common to most substances and processes is that the particles end up in so called sludge having high water contents. The nature of the resulting sludge differs widely, depending on the substances that are separated in the cleaning process and the structure of the cleaning process. For instance, sludge emanating from cleaning processes within the food industry may form a primary material to be further processed into protein for use in such products as for instance animal food. Sludge emanating from surface treatment industries, on the other hand, often consists of environmentally hazardous waste, which must be handled accordingly.

Generally, it is desirable in all processes that the volume of the resulting sludge be small, which could only be achieved by concentrating the particle contents in the sludge, by removing as large quantities of liquid as possible from the sludge.

EP 0 883 576 disclose a dewatering device for batchwise separation of liquid from particle-laden sludge. The dewatering device includes a cylindrical separation device with internal walls having apertures for evacuating the drained water. The apertures extent and configuration are adapted to the specific functional requirements on the equipment in dependence of the type of sludge for which the dewatering device is intended. Further, a bladder is located con-centrally inside the cylindrical separation device and is used for compressing the sludge in the separation device to improve dewatering, at least for some kind of sludge materials. A pipe is used for infeed of sludge and conducts the sludge into the separation device, and the lower part of the separation device is formed with a pipe for removal of liquid separated by the dewatering device. The bottom of the dewatering device comprises an openable hatch through which the dewatering device is emptied. After the desired drainage the dewatered material has the shape of a hollow cylinder batch. Opening the bottom hatch, allowing the batch of dewatered material to fall out by gravity, empties the separation device. The dewatering device disclosed in EP 0 883 576 is particularly useful since it can handle many different types of sludge.

However, a problem with the dewatering device shown in EP 0 883 576 is that the emptying of the separation device does not work properly for all kinds of dewatered material. For instance, problems may occur when dewatering sludge with high contents of incompressible material, such as calcium carbonate, calcium hydroxide, glass, stone powder, sand, and cellulose and textile fibers. When such sludge material is filled into the separation device, large amounts of liquid are drained through the apertures of the separation device simultaneously the filling of the sludge is still ongoing. This allows more sludge to be filled into the separation device than what would be the case for a more compressible sludge type. However, as sludge material is filled into the separation device disclosed in EP 0 883 576, the bladder, which is of flexible material, is compressed by the sludge and hence the volume of the bladder is decreased. Particularly, for sludge with high contents of incompressible material, the bladder is compressed to a large extent, partly because the nature of such sludge material is more prone to compress the bladder, and partly since that the separation device is filled with more sludge, as described above. Hence, when the separation device is filled with sludge having high contents of incompressible material and compression using the bladder is about to begin, the sludge is already dewatered to such an extent that the bladder is not of much use. On the contrary, the sludge has compressed the bladder so that the maximum diameter of the dewatered material exceeds the size of the opening of the separation device. As a result, the batch of drained sludge is stuck in the separation device.

It has been shown that simply filling less sludge into the separation device can reduce the problem of overfilling the dewatering device described above, at least to some extent. However, it is difficult to find an optimized level, which does not cause an unnecessarily inefficient process. Therefore, it is an object of the present invention to further reduce the problem of emptying the dewatering device.

### SUMMARY OF THE INVENTION

It is therefore an object of the present invention to at least partly overcome the above-mentioned drawbacks and to provide an improved dewatering device, which in particular provides an improved emptying function for many different types of sludge material. These and other objects are met by a dewatering device according to claim 1, and with a method for separation of liquid from particle-laden sludge using a dewatering device according to claim 7. Preferred embodiments of the present invention are presented in the dependent claims 2-6 and 8-11.

According to a first aspect the inventive concept relates to a dewatering device for batchwise separation of liquid from particle-laden sludge, the dewatering device comprising a closed, downwards openable container having at least one liquid-pervious wall, the container being arranged to be filled with sludge during a filling phase, a bladder located centrally inside the container, the bladder is adapted to be filled with a fluid, and a valve system for controlling the pressure of the fluid inside the bladder, wherein compression of the bladder is prevented by having the valve system adapted to maintain an overpressure of the fluid inside the bladder, in relation to the surrounding pressure, in use of the dewatering device during the filling phase. Pressurizing the bladder during the entire filling phase inhibits that the sludge, which is filled into the bladder during the filling phase, compresses the bladder. Thus, the risk if overfilling the container with sludge is minimized, even for sludge types with a high degree of incompressible material.

Preferably, the dewatering device further comprises a duct that is lead-through the bladder so that at least one part of the duct is located inside the bladder in order to supply the fluid into the bladder, wherein said valve system is arranged on the duct. The duct with the valve system allows for a simple and reliable construction and provides a manageable system for supplying fluid into the bladder as well as controlling the pressure of the fluid inside the bladder.

Suitably, the duct perforations for supply of the fluid to and discharge of the fluid from the bladder, respectively. Preferably, the total area of the perforations is larger than the cross section area of the duct to allow for a rapid discharge or supply of the fluid from and to the bladder, respectively.

Preferably, the fluid used for pressurizing the bladder is air. Air is simple to handle and necessitate few technical arrangement compared to other fluids.

Preferably, the dewatering device further comprises means for applying an essentially downwardly-directed force onto drained sludge collected in the container for emptying the container. The means can apply a force onto the drained sludge, which ensures that the material can, after the force has been applied, fall out from the container through an opening in the lower part of the container. The means is particularly advantageous when emptying the container from drained sludge that is stuck onto the interior perforated wall of the container. The means then provides a force to overcome the high shear stresses between the drained sludge and the perforated wall. In addition, even for drained sludge that will fall out from the container simply by opening a bottom hatch of the container, the means can be advantageous. The means can speed up the emptying process and even keep the drained sludge together better when it falls out from the container. That, in turn, might facilitate the following handling of the drained sludge as well as reduce the residue inside the container, which makes the cleaning of the container easier.

Preferably, the means for applying an essentially downwardly-directed force is adapted to apply an essentially instantaneous force onto the drained sludge collected in the container for emptying the container. The drained sludge has usually such a high dryness that it forms a batch that is held together as a solid clod. Hence, the intended force does not have to be exerted upon the drained sludge for a certain period of time, but an essentially instantaneous force is enough. Such a force normally requires less energy in total. In addition, no bulky arrangement for conveying the drained sludge out from the container is necessary.

According to a second aspect, the inventive concept relates to a method for separation of liquid from particle-laden sludge using a dewatering device, which comprises a container, and a bladder located centrally inside the container, wherein the method comprises the steps of:
filling the bladder with a fluid until a desired overpressure of the fluid inside the bladder, in relation to the surrounding pressure, is obtained,
filling the container with sludge to a desired level whereupon the filling operation is interrupted, in a filling phase,
during the filling phase, preventing compression of the bladder by maintaining said overpressure inside the bladder using a valve system,
removing liquid from the container by drainage through at least one liquid-pervious wall of the container until a desired dryness of the sludge is obtained, and
emptying the drained sludge through an openable hatch located in the lower part of the dewatering device.

Preferably, the step of removing liquid from the container further includes the step of:
expanding the bladder to force the sludge towards the liquid-pervious wall of the container.

The bladder can be used for compressing the sludge in the container, which can make the dewatering process more efficient for some kind of sludge materials. Suitably, the step of expanding the bladder is done using said valve system. Thus, the valve system, located on the duct for supplying fluid into and out from the bladder, can be used both for the purpose of controlling the pressure inside the bladder during the phase of filling sludge into the container, as well as for the additional step of controlling the expansion of the bladder.

Preferably, the step of emptying the drained sludge further comprises the step of:
applying an essentially downwardly-directed force onto drained sludge collected in the container for emptying the container.
   Suitably, the essentially downwardly-directed force onto the drained sludge collected in the container is essentially instantaneous.

The above mentioned advantages of the dewatering device apply analogously to the method of the present invention.

### BRIEF DESCRIPTION IF THE DRAWINGS

This and other aspects of the present invention will now be described in more detail, with reference to the appended drawings showing currently preferred embodiments of the invention.

FIG. 1 is a partly cut open perspective view of the dewatering device according to the invention.

FIGS. 2a-e show sections of the dewatering device according to the invention.

### DETAILED DESCRIPTION OF A PREFERRED EMBODIMENT

The invention will now for the purpose of exemplification be described in more detail by means of an example and with reference to the accompanying drawings.

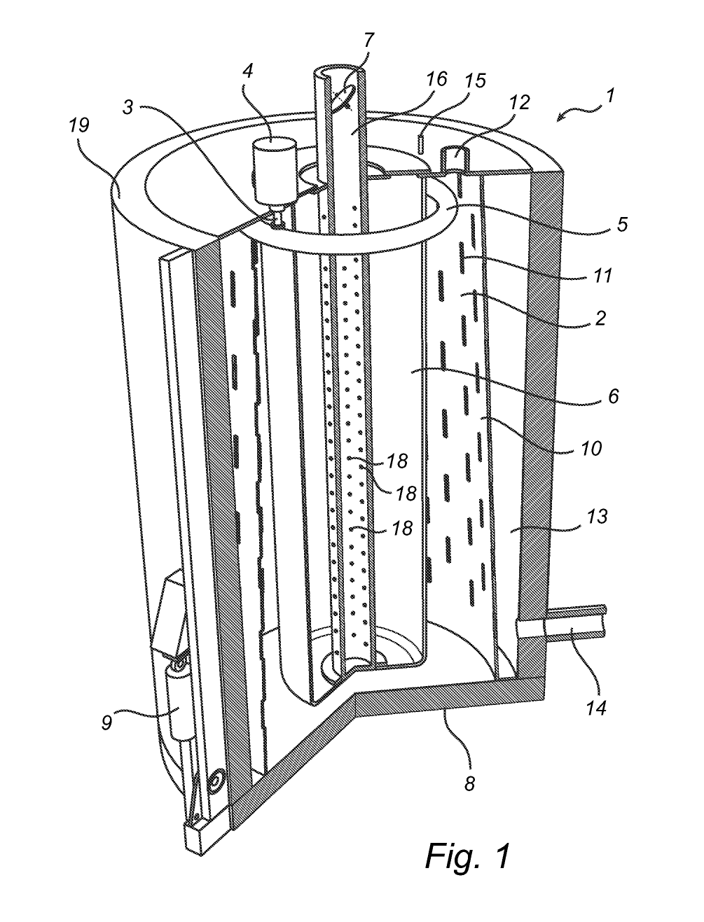

FIG. 1 shows a dewatering device 1 according the presently preferred embodiment of the invention. The dewatering device 1 comprises a closed, generally cylindrical receptacle 19. A container 2 is arranged concentrically inside the receptacle 19. Further, a bladder 2 is arranged concentrically inside the container 2, and a duct 16 is arranged concentrically inside the container 2.

The container 2 comprises a tank 10 having walls which are slightly conical, tapering inwardly aloft, so that the container 2 is shaped as a truncated cone. The largest diameter of the tank 10 is slightly smaller than the internal diameter of the receptacle 19, and the larger of the ends of the conical tank 2 is faced downwards, towards the inner bottom of the receptacle 19. The tank 10 is perforated by apertures 11 and made of metal and functions as a liquid-pervious wall 10, through which liquid from the sludge 20 is drained, from the inside to the outside of the container 2. The extent and configuration of the apertures are adapted to the specific functional requirements on the equipment in dependence of the type of sludge for which the container 2 is intended.

The bladder 6 is arranged concentrically inside the tank 10 of the container 2. The bladder is of a material, which can expand, such as rubber, when filled with a fluid, such as air or liquid. The duct 16 is located centrally inside the bladder 6 for supplying fluid into and discharging fluid out from the bladder 6, respectively. The duct 16 is lead-through the bladder 6 so that one part of the duct is located inside the bladder 6. Further, the duct 16 has several perforations 18, through which fluid is provided to and discharged from the bladder 6. The perforations 18 are spread all along the duct 16 within the bladder 6. The total area of the perforations 18 is larger than the cross section area of the duct 16.

At the duct 16, outside of the bladder 6, a valve system 7 is arranged, which controls the supply of fluid to and discharge of fluid from the bladder, respectively. Thus, the valve system 7 can be used to control and maintain a certain pressure of the fluid inside the bladder 6. In this preferred embodiment the valve system 7 comprises a butterfly valve 7 but any suitable valve type or types can be used.

The particle dewatering device 1 is formed with an inlet 12 for infeed of sludge 20. The inlet 12 conducts the sludge 20 to the space situated interiorly of the container 2. The lower part of the receptacle 19, outside of the container 2, is formed with an outlet 14 for removal of liquid separated by the dewatering device 1. In the space interiorly of the container 2, a sensor 15 is located to emit a signal in response to a filled container 2.

The bottom of the receptacle 19 comprises a flange with a seal (not shown in detail) against which pressingly abuts an openable hatch 8. The hatch 8 is preferably actuated mechanically by means of for instance a piston-and-cylinder unit 9 located in close connection with the hatch 8 on the side of the dewatering device 1. The hatch 8 covers the entire base of the container 2 whereby the conical tank 10 is completely open downwards when the hatch 8 is in its open position.

Further, the butterfly valve 7 controls the pressure of the fluid inside the bladder 6 and is adapted to maintain an overpressure of the fluid inside the bladder 6, in relation to the surrounding pressure, during the phase of filling sludge 20 material into the tank 10 of the container 2. The valve 7 ensures that the bladder 6 maintains a mostly inflated shape and thus prevents that the bladder is compressed into a rather hourglass shape, by lateral forces from the sludge 20 onto the bladder 6. If the bladder 6 is compressed and the volume of the bladder 6 is decreased, problems might occur when the container 2 is to be emptied since the maximum diameter of the drained sludge might exceed the size of the opening of the container 2. This problem arises particularly for sludge 20 with high contents of incompressible material. For such sludge material the bladder 6 is not powerful enough to be able to redistribute the sludge 20, even if the container 2 is only partly filled with sludge 20, provided that the container not so empty that the dewatering process becomes ineffective. However, it has been surprisingly instead that the bladder 6 will not collapse during the filling phase thanks to said overpressure, as it does if filling such incompressible material according to prior art.

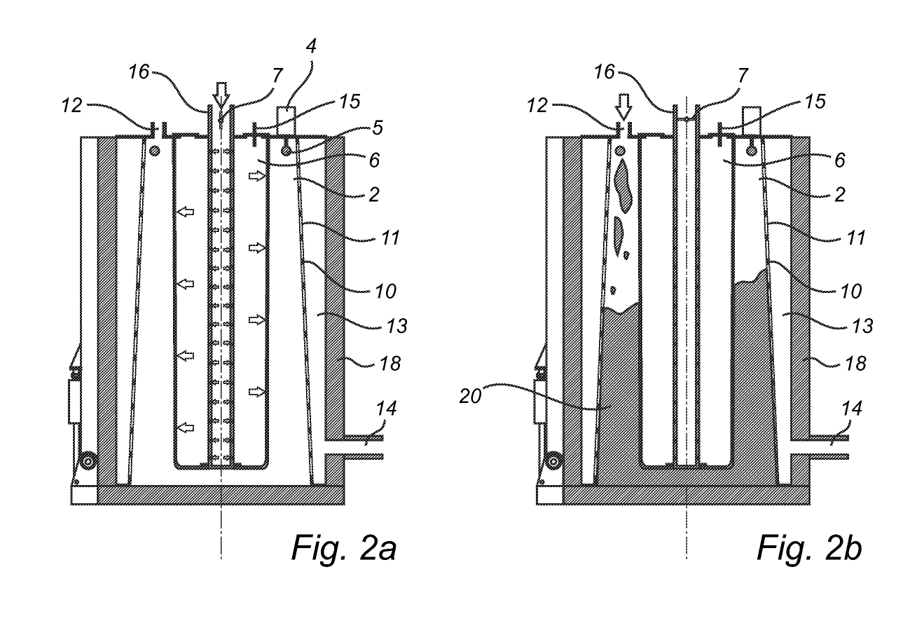

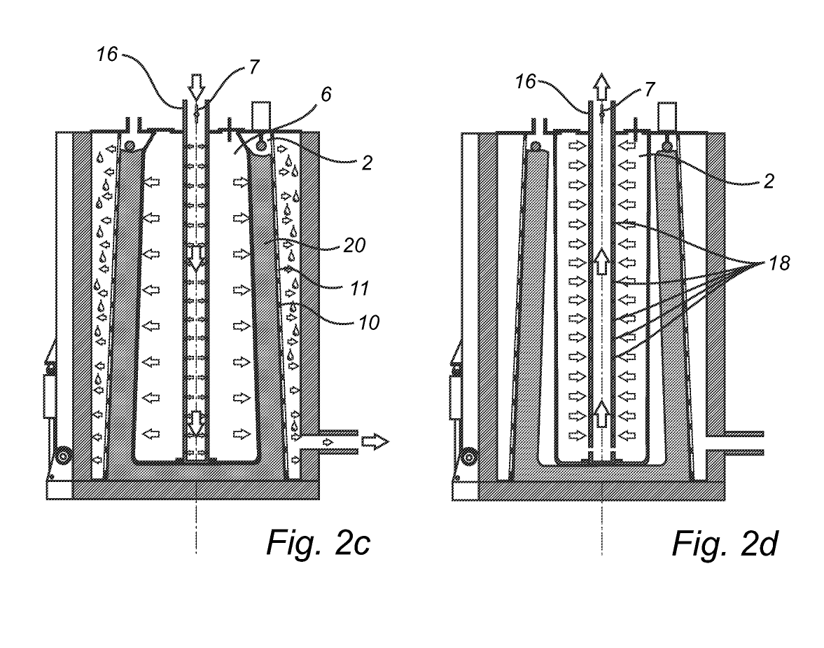

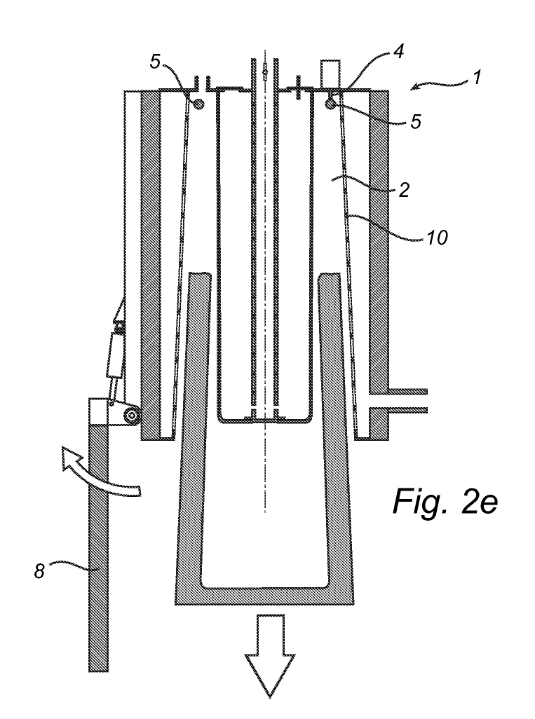

For dewatering of sludge materials with a high degree of incompressible material, the gravimetric run-off drainage through the apertures 11 of the container 2 is sufficient, i.e. material that does not bind water and the compression of which only marginally reduces the volume. Examples of materials of this type are iron oxide, calcium hydroxide, calcium carbonate, sand, machine shavings and scales. For other types of sludge material, such as sewage and sludge from food industry, which has high contents of proteins, the dewatering process can be improved by using the expandable bladder 6, which is shown in FIG. 1. This is described in more detail below with reference to FIG. 2c.

Further, the dewatering device 1 has according to the present invention means 3 for applying an essentially downwardly-directed force onto the drained sludge for emptying the tank 2. In the preferred embodiment shown in FIG. 1, the means 3 comprises a pressure piston 4 that, when activated, exerts a force onto a ring-shaped disc 5 arranged concentrically to and in the upper part of the dewatering device 1, which in turn exerts a force onto the material inside the tank 10. Thus, the main purpose of the means 3 is to assist in emptying the container 2 in case the drained sludge is stuck onto the interior walls 10 of the container 2 after the sludge has been dewatered and the hatch 8 has opened. This is done by applying an essentially downwardly-directed force onto the drained sludge. In this preferred embodiment, the drained sludge has the shape of a truncated cone, due to the shape of the container, where the upper surface is the smaller one the two base surfaces. The ring-shaped disc 5 allows the force to be transmitted to a quite large portion of the upper surface of the drained sludge.

The means 3 can be operated hydraulically, electrically, manually, or by any other type of suitable power. It is also possible to have a configuration of the means 3 such that the force onto the ring-shaped disc 5, or any other suitable force transmission system 5, is applied by more than one power-generation device 4. For instance, one or several power-generation devices can supply the force evenly onto the ring-shaped disc can be used. It is preferred that the downwardly-directed force is an instantaneous force, which acts only during a short time, but with a high force. This instantaneous force is enough to overcome the forces acting on the drained sludge from the apertures 11 and the tank 10 and to induce a fall-out of the sludge from the tank 10.

Alternatively, the ring-shaped disc 5 can be excluded and instead the force form the power-generation device 4 can be applied directly onto the drained sludge or via a plate or washer that only covers a minor part of the upper surface of the drained sludge. Yet another possible embodiment of the means 3 is a flexible tube, such as a rubber tube, which, when activated, is rapidly filled with a gas, thus expanding and exerting a force onto the drained sludge. Such a rubber tube would replace both the ring-shaped disc 5 and the pressure piston 4.

Flushing nozzles (not shown) can be positioned inside the dewatering device 1 and directed as to flush clean the perforated tank after emptying.

FIGS. 2a-e show the different steps of the operation of the dewatering device 1, which are explained below. In the dewatering operation the following steps are performed:

As is illustrated in FIG. 2a, the bladder 6 is filled with a fluid using the duct 16, located concentrically inside the bladder 6, via the inlet openings 17 in the lower part of the bladder 6. To optimize the operation of the dewatering device, the amount of fluid that is filled into the bladder 6 is adapted for the particular sludge 20 that is to be dewatered and is derived and precalculated based on the density of the sludge 20 prior to dewatering. When a desired amount of the fluid has been filled into the bladder 6, thus pressurizing the bladder 6, it is sealed using the valve 7. The valve 7 is then kept close during the following phase of filling sludge 20 into the container 2, which is referred to as the filling phase, to maintain the overpressure inside the bladder 6 during the filling phase.

FIG. 2b shows the filling phase when sludge 20 is filled into the container 2. Via the inlet 12, the container 2 is filled with sludge 20 to a desired level, which is sensed by a level sensor 15, whereupon the filling operation is interrupted. By gravimetric run-off, liquid is removed from the container 2. This is done by liquid being drained through the apertures 11 in the tank 10 of the dewatering device 1 into the adjacent ambient space 13 in the receptacle 19, from which space 13 it is discharged through the outlet 14. In this manner, the volume of the sludge 20 supplied to the container 2 is reduced and the particle concentration is increased.

When the volume has been reduced to a predetermined level, sludge 20 is again filled up to the filling level. The run-off of liquid is continued until the lower level is again obtained and refill of sludge 20 takes place again. This procedure is repeated a predetermined number of times, which may be set optionally, until the particle concentration of the sludge 20 has reached a desired value.

If the sludge 20 material is of a kind that needs to be compressed (as discussed above), the sludge 20 is compressed following the drainage period by expanding the bladder 6. Expanding of the bladder 6 is performed by filling the bladder 6 with fluid using the same arrangement with the duct 16 and the inlet openings 17 in a similar manner as described above referring to pressurizing the bladder 6. The fluid is supplied through the duct 16, past the open valve 17 and into the bladder 6 via the inlet openings 17. As the fluid is supplied into the bladder 6, the bladder 6 expands gradually and the sludge 20 in the container 2 is displaced towards the interior wall 10, causing the pressure to rise and the liquid to be forced outwards and evacuated through the apertures 11 of the interior wall 10. This step is illustrated in FIG. 2c.

FIG. 2d shows a step where the fluid inside the bladder 6 is discharged from the bladder 6 after the above described compression is completed. The fluid is evacuated through the perforations 18 in the duct 16, which decreases the volume of the bladder 6. The valve 17 is thus open.

FIG. 2e illustrates how the container is being emptied. After the desired drainage/run-off period, and upon completion of the compression, the dewatering device 1 is emptied which is done in two steps. Firstly, the bottom hatch 8 is opened. Secondly, a downwardly-directed force is applied onto the drained sludge collected in the container 2, if the sludge does not fall out by its own weight. In the embodiment shown in the figures of this application, the force originates from the hydraulic pressure piston 4 and is transmitted to the drained sludge via the ring-shaped disc 5. The force is instantaneously-operating onto the drained sludge and releases the drained sludge from the interior wall 10 of the container 2. The drained sludge is then allowed to fall out from the container 2 by gravity.

After emptying, the hatch 8 is re-closed and the inner face of the dewatering device is flushed with the aid of the flushing nozzles (not shown) for a desired, suitable period of time, whereupon a new cycle of the dewatering process may be initiated.

Due to the large number sludge material types that can be dewatered with the dewatering device 1, one or several of the above described steps of the operation of the dewatering device 1 can be left out, depending on the sludge type. For instance, it might not be necessary to keep a fluid inside the bladder 6 at an overpressure during the filling phase for some kinds of sludge materials, i.e. materials that are easily compressed by the bladder 6. On the contrary, for sludge with a high degree of incompressible material, the step of refilling sludge and/or compressing the sludge with the bladder 6 might not be necessary. Obviously, drained sludge that, after opening of the hatch 8, falls out by gravity without the use of the means 3 can be allowed to do so. However, the means 3 might be useful anyway since it possibly can speed up the emptying process and even keep the drained sludge together better when it falls out from the container 2. That, in turn, might facilitate the following handling of the drained sludge as well as reduce the residue inside the container 2, which makes the cleaning of the container 2 easier.

The person skilled in the art realizes that the present invention by no means is limited to the preferred embodiment described above. On the contrary, many modifications and variations are possible within the scope of the appended claims.

1. Dewatering device for batchwise separation of liquid from particle-laden sludge, the dewatering device comprises a closed, downwards openable container having at least one liquid-pervious wall, said container being arranged to be filled with said sludge during a filling phase, a bladder located centrally inside the container, the bladder is adapted to be filled with a fluid, and a valve system for controlling the pressure of the fluid inside the bladder, wherein compression of the bladder is prevented by having the valve system adapted to maintain an overpressure of the fluid inside the bladder, in relation to the surrounding pressure, in use of the dewatering device during said filling phase.

2. Dewatering device according to claim 1, further comprising a duct that is lead-through the bladder so that at least one part of the duct is located inside the bladder in order to supply said fluid into the bladder, wherein said valve system is arranged on the duct.

3. Dewatering device according claim 2, wherein the duct, has perforations for supply of the fluid to and discharge of the fluid from the bladder, respectively.

4. Dewatering device according to claim 1, wherein the fluid is air.

5. Dewatering device according to claim 1, wherein the valve system comprises a butterfly valve.

6. Dewatering device according to claim 1, further comprising means for applying an essentially downwardly-directed force onto drained sludge collected in the container for emptying the container.

7. Method for separation of liquid from particle-laden sludge using a dewatering device which comprises a container, and a bladder located centrally inside the container, wherein the method comprises the steps of:
filling the bladder with a fluid until a desired overpressure of the fluid inside the bladder, in relation to the surrounding pressure, is obtained,
filling the container with sludge to a desired level whereupon the filling operation is interrupted, in a filling phase,
during said filling phase, preventing compression of the bladder by maintaining said overpressure inside the bladder using a valve system,
removing liquid from the container by drainage through at least one liquid-pervious wall of the container until a desired dryness of the sludge is obtained, and
emptying the drained sludge through an openable hatch located in the lower part of the dewatering device.

8. Method according to claim 7, wherein the step of removing liquid from the container further includes the step of:
expanding the bladder to force the sludge towards the liquid-pervious wall of the container.

9. Method according to claim 8, wherein the step of expanding the bladder is done using said valve system.

10. Method according to claim 7, wherein the step of emptying the drained sludge further comprises the step of:
applying an essentially downwardly-directed force onto the drained sludge collected in the container for emptying the container.

11. Method according to claim 10, wherein said essentially downwardly-directed force onto the drained sludge collected in the container is essentially instantaneous.
